(19) United States
(12) Patent Application Publication
(10) Pub. No.: US 2009/0263700 A1
(43) Pub. Date: Oct. 22, 2009

(54) FUEL CELL ASSEMBLY

(75) Inventors: Rongzhong Jiang, Olney, MD (US); Deryn Chu, Potomac, MD (US)

Correspondence Address: U S ARMY RESEARCH LABORATORY;ATTN: RDRL-LOC-I, 2800 POWDER MILL RD, ADELPHI, MD, 20783-1197, US

(73) Assignee: US Government as Represented by Secretary of the Army, Adelphi, MD (US)

(21) Appl. No.: 12/104,657

(22) Filed: Apr. 17, 2008

(51) Int. Cl. H01M 8/02

(52) U.S. Cl. 429/34; 429/12; 429/40

(57) ABSTRACT

A fuel cell assembly is comprised of a plurality of stack units. Each stack unit includes a first cell and a second cell, and each cell includes an electrode of a first polarity and an electrode of a second polarity, with an ion permeable membrane disposed therebetween. The stack unit further includes a fuel container which comprises a housing defining a fuel chamber having a first and second open surface. The first and second cells are disposed on opposite sides so that electrodes of each cell having the first polarity are disposed in fluid contact with the fuel chamber. The assembly further includes an oxidizer supply member disposed between adjacent pairs of stack units. The oxidizer supply member includes an oxidizer chamber having first and second open surfaces. The oxidizer supply member is disposed so that electrodes of the second polarity of adjacent stack units are in fluid contact with the chamber of the oxidizer supply member. The various stack units can be electrically interconnected in series, parallel, or mixed series parallel relationship. The fuel cell stack assembly are configured to operate in conjunction with a liquid fuel such as an alcohol, and using air as an oxidizer.

### GOVERNMENT INTEREST

The invention described herein can be manufactured, used, and licensed by or for the United States Government.

### FIELD OF THE INVENTION

This invention relates generally to fuel cells. More specifically, the invention relates to a fuel cell stack having a modular design. In specific instances, the invention relates to a fuel cell assembly which is adaptable for use with organic fuels in a direct air breathing mode.

### BACKGROUND OF THE INVENTION

Fuel cells are electrochemical devices in which a fuel and an oxidizer react to directly generate an electrical current. Fuel cells are silent and clean in operation and can provide power sources which have a high power to weight ratio. As a consequence, fuel cells are attractive energy sources for a large number of applications.

One class of fuel cells utilizes hydrogen as a fuel. The chemistry of such system is relatively simple; however, their operation requires the storage and delivery of a gaseous fuel which can complicate the system. Another class of fuel cells utilizes organic liquids as a fuel. These liquids typically comprise methanol or other alcohols. Fuel storage and delivery in such systems is relatively simple. In some instances, liquid fuel cells utilize air as an oxidizer, and can be configured so that they are “lair breathing” thereby eliminating the need for pumps or other gas delivery systems. Such liquid fuel, air breathing fuel cells can provide compact, mechanically simple power sources. However, presently implemented fuel cell stack configurations have not been able to fully achieve all of the potential benefits of such systems.

One approach in the prior art to the fabrication of fuel stack designs utilizes the “bipolar plate” design wherein a single bipolar plate serves as a current collector for both anode and cathode electrodes in two adjacent single cells. One surface of the plate is in contact with an anode of the cell and the other with the cathode. When electricity passes through the bipolar plate, electrical polarization occurs between the two sides thereof. These plates are typically made of graphite, but in some instances they are fabricated from a metal sheet. The bipolar plate design provides a compact volume and high internal conductivity, together with a rigid, stacked structure; but, it has the disadvantages of requiring precise thermal and liquid flow management, which generally requires the use of fuel and air pumps. Consequently, such designs are expensive and difficult to operate. Some examples of prior art showing bipolar plate designs of fuel stacks are found in U.S. Pat. Nos. 5,776,624; 5,496,655; 5,798,188; and 6,284,401.

In other instances, the prior art has utilized fuel cell stacks with non-bipolar plates. In systems of this type, each current collector will serve only as an anode or cathode electrode in the fuel cell; and as a consequence, each cell in the stack operates independently. The disadvantages of the non-bipolar design are high internal resistance, fragile stack structure, low power output and fuel leakage. These non-bipolar designs are primarily used for hydrogen/air fuel cells and only occasionally in liquid fuel cell systems. Some prior art examples of non-bipolar designs are found in U.S. Pat. Nos. 5,709,961; 5,958,616; 6,132,895; 6,268,077; 6,194,095; and 5,958,616. In most instances, such non-bipolar designs are configured so that the single cells are arranged in a plane, and this type of a design is generally detrimental to achieving high power density outputs.

In most instances, high density fuel cell stacks require the use of pumps for delivering air or other oxidant thereto. The prior art has implemented several designs in an attempt to make fuel cell stacks directly air breathing so as to minimize cost and weight. However, prior art air breathing stack assemblies have been found to be fragile and prone to fuel leaking and/or have poor electrical contact between the electrodes and current collectors. Some prior art approaches to the fabrication of direct air breathing fuel cells are found in U.S. Pat. Nos. 6,268,077; 5,645,950; 5,514,486; 5,595,834; 5,935,725; 6,040,705; and 5,709,961.

As will be described hereinbelow, the present invention provides a fuel cell stack assembly which is simple in construction, rugged, and efficient. The stack assembly of the present invention provides a very high power density, and are configured to operate with a liquid fuel such as an alcohol, and to be directly air breathing. Furthermore, the system of the present invention is modular and allows for ready configuration of a series of fuel cells into series, parallel, or mixed series parallel arrays so as to allow for the selectable control of the current and voltage output of the stack. These and other advantages of the invention will be apparent from the drawings, discussion and description which follow.

### BRIEF DESCRIPTION OF THE INVENTION

Disclosed herein is a modular fuel cell assembly comprised of a number of different subunits. The fuel cell assembly includes a plurality of stack units, and each stack unit comprises a first cell and a second cell. Each of the cells includes an electrode of a first polarity, an electrode of a second polarity, and an ion permeable membrane disposed therebetween. The stack units each further include a fuel container which comprises a housing defining a fuel chamber having a first open surface and a second open surface. The open surfaces are in a spaced apart relationship, and the stack unit is configured so that a first cell is disposed in contact with the first side of the fuel container so that the electrode of the first polarity of the first cell is in fluid communication with the first open surface of the container and the second cell is disposed in contact with the second side of the fuel container so that the electrode of the first polarity of the second cell is in fluid communication with the second open surface of the container.

The fuel cell assembly further includes at least one oxidizer supply member which is configured as a housing defining an oxidizer chamber having a first open surface and a second open surface in a spaced apart relationship therewith. The stack units are disposed so that an oxidizer supply member is disposed between, and separates, two stack units such that the first open surface on the oxidizer supply member is in fluid communication with an electrode of the second polarity of one of the stack units and the second open surface of the oxidizer supply member is in fluid communication with the electrode of the second polarity of another of the stack units. The electrodes of the cells in some embodiments have current collectors associated therewith, and by appropriately interconnecting these electrodes in a series, parallel, or mixed series parallel relationship, the overall voltage and power output of the stack are selectably controlled. The electrodes of the cells in some embodiments have appropriate catalysts associated therewith so as to allow them to be used with liquid, organic fuels.

### BRIEF DESCRIPTION OF THE DRAWINGS

FIG. 1 is a front elevation view of a cell which is used in the assembly of the present invention;

FIG. 2 is a cross-sectional view of the cell of FIG. 1 taken along line 2-2;

FIG. 3 is a perspective view of a fuel container which is utilized in an assembly of the present invention;

FIG. 4 is a perspective view of an oxidizer supply member which is utilized in the assembly of the present invention;

FIG. 5 is an exploded view of a fuel cell stack assembly in accord with the present invention;

FIG. 6 is a schematic depiction of a fuel cell stack assembly of the present invention showing the liquid delivery system;

FIG. 7 is a schematic depiction of a fuel cell stack assembly of the present invention showing the electrical interconnection of the various components thereof; and

FIG. 8 is a graph showing the performance characteristics of a fuel cell stack assembly of the present invention.

### DESCRIPTION OF THE INVENTION

The present invention comprises a modular fuel cell stack assembly which is implemented in a variety of configurations. The assembly includes a number of stack units each of which includes a first and second cell and a fuel container. At least two of these stack units are combined with an oxidizer supply member to form a fuel cell stack assembly. A number of pairs of stack units and oxidizer supply members are assembled into yet larger fuel cell stacks. By appropriately interconnecting the electrodes of the stack, voltage and current outputs can be selectably controlled.

The principles of the invention will be explained with regard to one specific stack assembly, and it is to be understood that this is for purposes of illustration and yet in alternate embodiments, other variously configured assemblies are implemented.

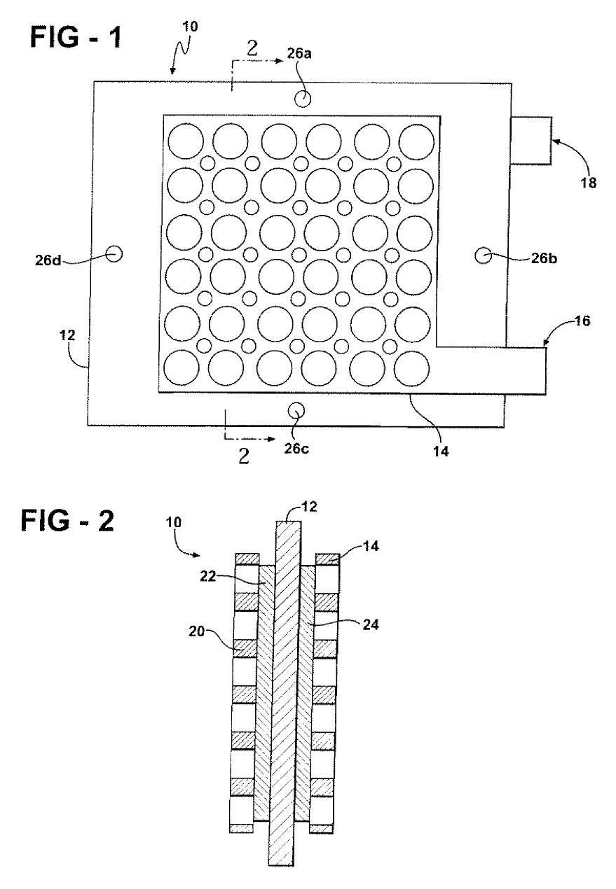

Referring now to FIG. 1, there is shown a front elevational view of a basic cell 10 of the type which is incorporated into the assembly of the present invention. Visible in FIG. 1 is a portion of an ion permeable membrane 12, as will be explained in greater detail hereinbelow. Also visible is a first current collector 14 having an electrode tab portion 16 associated therewith. A tab portion 18 of a second current collector is also shown in FIG. 1. FIG. 2 is a cross-sectional view of the cell 10 of FIG. 1 taken along line 2-2 As will be seen in FIG. 2, the cell 10 includes an ion conductive membrane 12 which in particular embodiments comprises a proton conductive membrane. Such membranes are known in the art and in particular instances are comprised of perfluorosulfonate polymers. Such membranes are available from the DuPont Corporation under the trademark Nafion. As shown, the membrane includes four holes 26a-26d therein. These holes will be utilized in the assembly of the finished fuel cell. As will be seen, the current collector 14 includes a pattern of large and small holes defined there through. These holes maximize the transport of air and fuel to other components of the fuel cell. Other hole patterns, including mesh structures, expanded metal structures and the like can be similarly employed.

The cell 10 of FIG. 2 includes a first electrode 22, which in this embodiment comprises the anode of the cell. As such, this electrode is in contact with the fuel during the operation of the fuel cell. In this particular embodiment, the electrode 22 is comprised of a body of electrically conductive carbonized cloth which is coated on both sides thereof with carbon black, and in this embodiment, the anode 22 includes a catalyst thereupon which is operative to facilitate the oxidation of the fuel during the operation of the fuel cell. The catalyst, in this particular instance, comprises a mixture of platinum, ruthenium and osmium. The electrode is liquid porous and hydrophilic.

The cell 10 further includes a second electrode 24, which in this instance is the cathode of the cell. In the operation of the fuel cell, oxygen is reduced at this electrode. The second electrode 24 is also comprised of a body of carbonized cloth, and, in some embodiments, includes a platinum catalyst thereupon. The carbon cloth of the second electrode has a hydrophilic coating of carbon black on the inner surface thereof which is the surface which is contact with the membrane 12. The outer surface of the electrode 24 is uncoated and is hydrophobic. It is this side which contacts air during the operation of the cell.

Also visible in FIG. 2 is the first current collector 14 as described above, and a second current collector 20. These current collectors are in electrical contact with the first and second electrodes 22, 24 and are fabricated from an electrically conductive material such as graphite, or a thin metal sheet. As will be seen, the current collectors 14, are perforated so as to allow for passage of liquid and air therethrough.

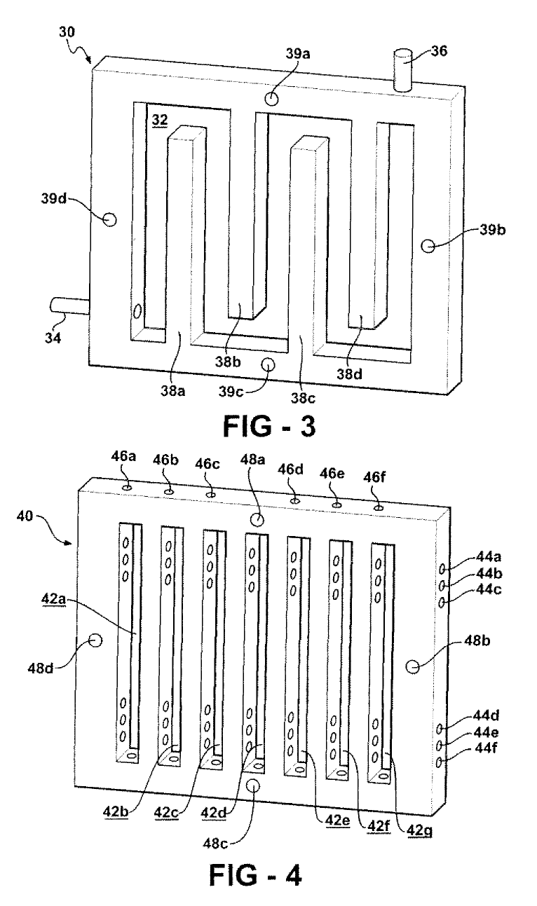

Referring now to FIG. 3, there is shown a fuel container 30 which is used in the assembly of the fuel cell stack. The fuel container 30 is fabricated from an electrically insulating material such as a polymeric material, although, in some embodiments, it is also fabricated from an electrically conducting material provided that an electrically resistive coating is disposed thereupon. The fuel container 30 is configured to define a fuel chamber 32 therein. As will be seen from FIG. 3, the fuel container includes a fuel inlet 34 and a fuel outlet 36 in fluid communication with the chamber 32. In the FIG. 3 embodiment, the fuel container 30 includes a number of projections 38a-38d configured as fingers which project into, and subdivides, the chamber 32. These projecting members define a fluid flow path through the chamber so that when fluid is flowed from the inlet 34, through to the outlet 36, it follows a sinuous path. The two sides of the fuel chamber 32 are generally open, and this is so as to allow fluid in the chamber 32 to contact the electrodes of cells which are disposed on opposite faces thereof. It will also be noted that in this embodiment, the projections 38a-38d have faces which are coplanar with the front and rear surfaces of the fuel container. It will also be noted that in the illustrated embodiment, the fuel container 30 includes four holes 39a-39d defined therethrough.

As will be explained in more detail hereinbelow, when the fuel cell stack assembly is formed, a first cell, generally similar to the cell 10 of FIGS. 1 and 2, is disposed in contact with a first face of the fuel container 30 so that the fuel contacting (anode) electrode thereof is in fluid communication with the fluid chamber 32. A second cell is disposed on the opposite face of the fuel container 30 so that the fuel contacting (anode) electrode thereof is likewise in fluid communication with the fluid chamber 32. The projections 38a-38d, in addition to defining a fluid path through the chamber, functions to support and bias the cells. The cells are maintained in tight contact with the fuel container by bolts or other devices which pass through the holes 39 in the fuel container, and through corresponding holes 26 in the membranes of the cells.

Referring now to FIG. 4, there is shown an oxidizer supply member 40 which is also utilized in the fabrication of the fuel cell stack assembly. The oxidizer supply member 40, like the fuel container, is electrically nonconductive, and as such is fabricated from an electrically resistive material or from an electrically conductive material coated with a resistive coating. The oxidizer supply member 40 includes a plurality of oxidizer chambers 42a-42g. A first plurality of air channels 44a-44f extends through the oxidizer supply member 40 and allow for air flow between an external environment and the chambers 42. A second plurality of air channels 46a-46f extends at right angles to the first plurality and likewise establishes communication with the chambers. In this manner, very good airflow through the chambers is maintained without the need for any pumps or other such delivery apparatus.

In the assembly of the fuel stack structure, a first stack unit is disposed in contact with the oxidizer supply member 40 so that the air contacting (cathode) electrode of that stack unit is in contact with a first face of the oxidizer supply member 40. Likewise, a second stack unit is disposed so that its air contacting electrode (cathode) is likewise in contact with the air chambers 42. As is the case with the fuel container, the oxidizer supply member 40 also includes a series of holes 48a-48d which allow for passage of a bolt or other member which maintains the portions of the assembly in contact. The portions of the face of the oxidizer supply member between adjacent chambers 42 support and bias the electrodes.

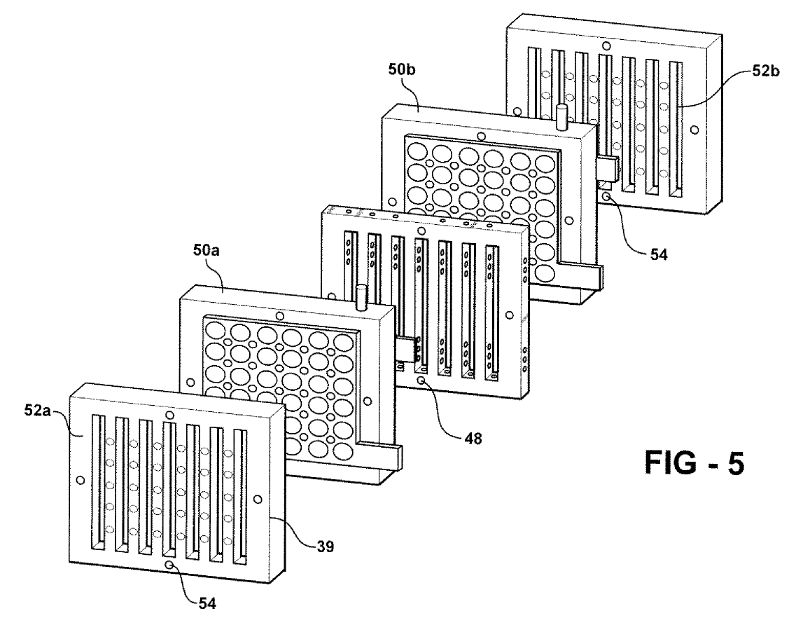

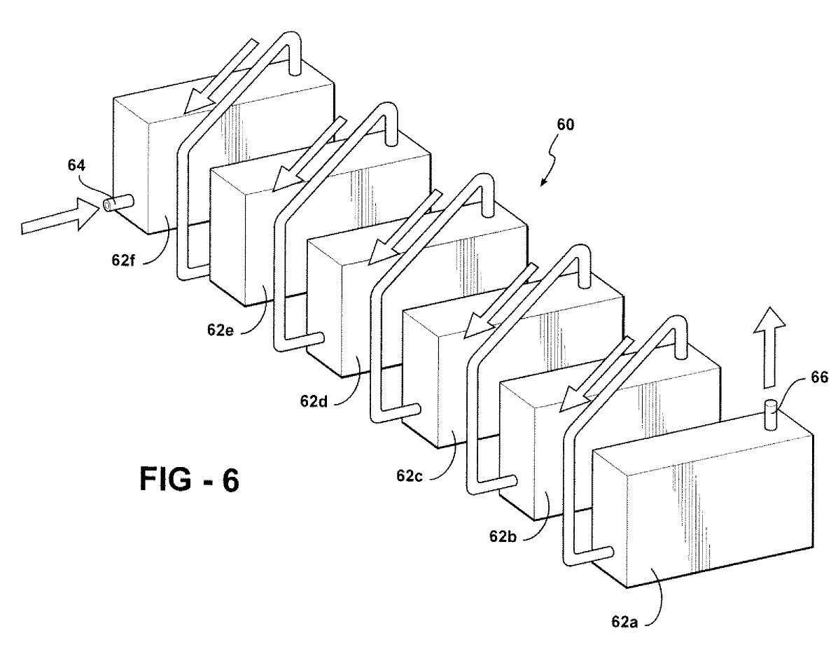

Referring now to FIG. 5, there is shown an exploded, perspective view of a fuel cell assembly in accord with the present invention. The assembly includes a first stack unit 50a and a second stack unit 50b as previously described. Each stack unit includes a first cell and a second cell disposed on opposite sides of a fuel container as previously described. An oxidizer supply member 40 is disposed between an adjacent pair of stack units 50a-50b. Fuel is flowed through the fuel containers of the respective stack units 50a-50b and this fuel is in fluid contact with the anodes of the assembly. The cathodes are in communication with a source of air either by the oxidizer supply member 40 which is disposed internally of the stack, or by first and second end plates 52a, 52b which cap off opposite ends of the stack. These end plates 52a, 52b are perforated and allow for contact of the cathodes of the respective stack units 50a, 50b with the ambient atmosphere. As noted above, the assembly is maintained in rigid contact by bolts or other such connecting members which pass through a series of holes 26, 39, 48 and 54 defined through the various components.

FIG. 5 represents a basic unit of the fuel cell stack assembly, and it is to be understood that this assembly can be further expanded by incorporating additional stack units and oxidizer supply members in the configuration of FIG. 5.

Referring now to FIG. 6, there is shown a schematic depiction of a fuel cell stack assembly in accord with the present invention. The assembly 60 includes a series of stack units 62a-62f as previously described. For purposes of illustration, oxidizer supply members are not shown; although it is to be understood that in accord with the teaching herein, one such member will be disposed between each adjacent pair of stack units. For example, one will be disposed between 62a and 62b, another between 62b and 62c, another between 62c and 62d, and so forth. Further shown in FIG. 6 is a fuel supply system wherein a fuel outlet of one stack unit is connected to a fuel inlet of the fuel container of an adjacent stack unit so that fluid can flow therebetween. Fluid flow is accomplished by gravity or alternatively it is aided by a pumping device. It is to be kept in mind that while FIG. 6 shows fluid flowing in series between the various cells from inlet 64 to outlet 66, other patterns of fluid flow are likewise employed. For example, fluid flows in parallel through the units. Other flow arrangements such as mixed series/parallel arrangements are likewise employed.

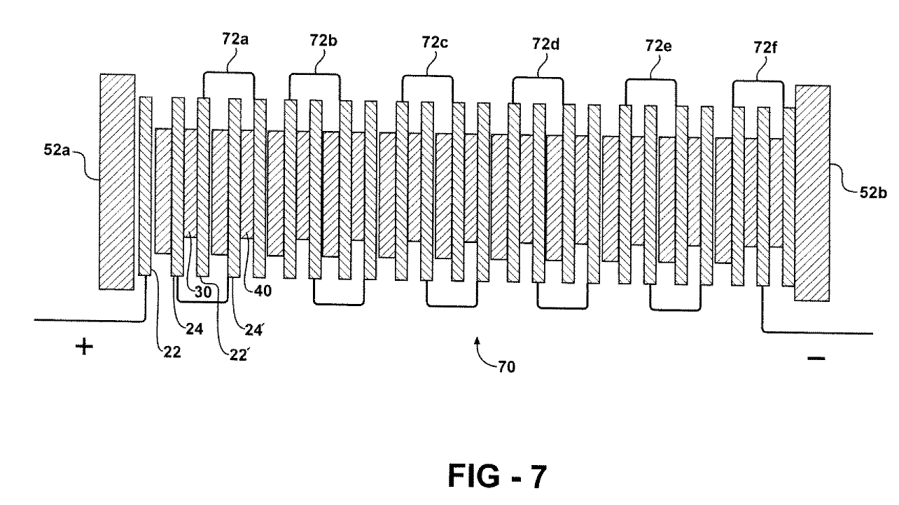

Referring now to FIG. 7, there is shown the electrical interconnection of the various electrodes of a fuel cell stack assembly 70. As will be seen from FIG. 7, the assembly 70 includes a plurality of stack units 72a-72f. Each stack unit includes a first cell having a first electrode 22, and a second electrode 24 with a body of membrane material 12 therebetween. Each stack unit further includes a fuel container 30 disposed between the two cells as previously described. Adjacent stack units 72 have an oxidizer supply member 40 therebetween all as previously described. As discussed with reference to FIG. 5, the assembly 70 includes end plates 52a, 52b. In the illustrated embodiment of FIG. 7, a series electrical connection between the stack units is established. In this regard, anode to cathode electrical connection between adjacent cells and stack units is established as illustrated. It is to be understood that series connections and mixed series connections are likewise established.

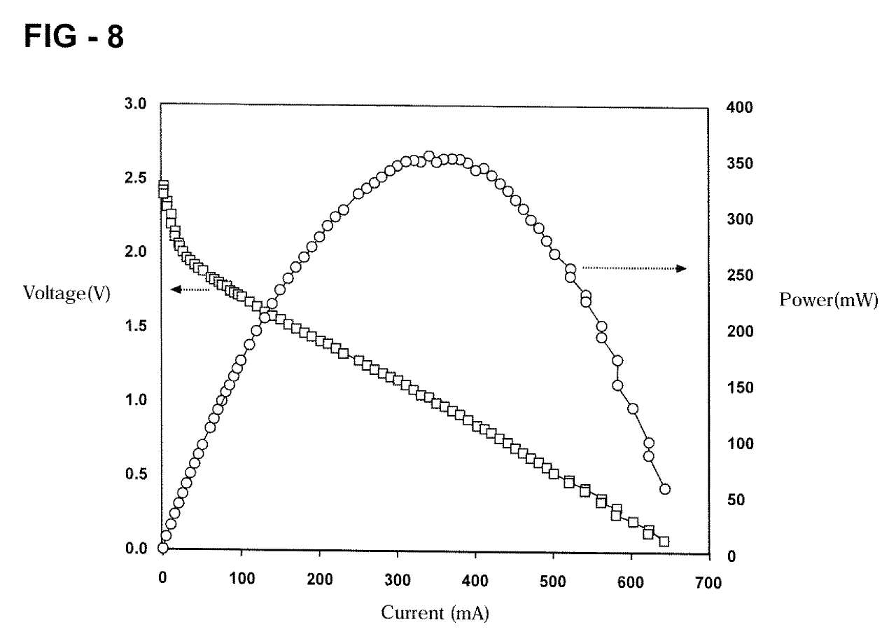

A four cell, air breathing fuel cell stack with a 9 cm electrode area was designed, processed and assembled in accord with the foregoing principles. This four cell stack used ambient air for an oxidant. Air delivery was by spontaneous convection, and no external pumping was required. Methanol was used as the liquid fuel. Specifically 3M methanol was used in testing the fuel cell assembly of FIG. 8. Lower or higher concentrations of methanol can be used to achieve better fuel efficiency on higher power density. The fuel cell stack was prepared utilizing Nafion 117 membrane material purchased from the DuPont Corporation. The membrane material was pretreated in boiling water with 3% H₂O₂ for two hours then boiled in 1 M H₂SO₄ for two hours. Thereafter, the membranes were washed with water and stored under water until utilized.

Cathodes were prepared utilizing one sided carbon cloth obtained from E-Tek, which was coated with 93% by weight platinum black catalyst obtained from Johnson Matthey and 7% by weight of a Nafion binder. Catalyst loading was 4 mg/cm² of unsupported platinum black for the cathode. The anode was prepared from two sided carbon cloth obtained from E-Tek. This electrode had 85% by weight of a PtRuOs catalyst which was prepared in house, and 15% of a Nafion binder. Catalyst loading was 3 mg/cm². The cell assemblies were prepared by hot pressing the anode, cathode and Nafion membrane together at 125° C.

The current collectors were comprised of thin titanium sheets. The fuel containers and air chambers, and end plates, were fabricated from glass loaded polymer and were of the general configuration illustrated in the foregoing figures. Teflon sealing gaskets were included between the components of the assembly, and the stack was mechanically stabilized by use of four bolts.

The thus prepared fuel cell stack assembly was then put into operation with the cells electrically connected in series. The fuel containers were charged with methanol and air was supplied by spontaneous convection. The stack was maintained at a temperature of 30° C., and open circuit voltage was measured at 2.6 V. FIG. 8 shows the discharge performance of the stack. The stack voltage decreases with increases in discharge current, and the output power increases with discharge current until reaching a maximum power point, then decreases as current further increases. A peak power of 360 mW was obtained.

The foregoing is illustrative of some specific embodiments of this invention. As was discussed above, other embodiments, modifications and variations will be apparent to those of skill in the art. The foregoing illustrations, examples and discussion are illustrative of specific embodiments of the invention, but are not meant to be limitations upon the practice thereof. It is the following claims, including all equivalents, which define the scope of the invention.

1. A fuel cell assembly comprising:
a) a plurality of stack units, each stack unit comprising:
a first cell and a second cell, each cell including an electrode of a first polarity, an electrode of a second polarity, and an ion permeable membrane disposed therebetween; and
a fuel container which comprises a housing defining a fuel chamber having a first open surface and a second open surface, said open surfaces being in a spaced apart relationship; wherein
said stack is configured so that said first cell is disposed in contact with a first side of the fuel container so that the electrode of said first polarity, of said first cell, is in fluid communication with the first open surface of said container, and the second cell is disposed in contact with a second side of the fuel container so that the electrode of said first polarity, of said second cell, is in fluid communication with the second open surface of said container; and
b) at least one oxidizer supply member which comprises a housing defining an oxidizer chamber having a first open surface and a second open surface, said open surfaces being in a spaced apart relationship; wherein
said plurality of stack units are disposed so that one of one of said at least one oxidizer supply member is disposed between, and separates, two members of said plurality of stack units such that the first open surface on each of said at least one oxidizer supply member is in fluid communication with an electrode of said second polarity of one of said stack units, and the second open surface of each of said at least one oxidizer supply members is in fluid communication with the electrode of said second polarity, of another of said stack units.

2. The assembly of claim 1, wherein at least some of said electrodes of at least some of said cells have a current collector associated therewith.

3. The assembly of claim 1, wherein said electrodes of said first polarity comprise anodes and said electrodes of said second polarity comprise cathodes.

4. The assembly of claim 1, wherein at least some of said electrodes have a catalyst associated therewith.

5. The assembly of claim 1, wherein the fuel container of at least some of said stack units has a fuel inlet and a fuel outlet associated therewith, said inlet and said outlet being in fluid communication with the fuel chamber.

6. The assembly of claim 1, wherein the fuel container of at least one of said stack units includes a guide structure which establishes a fluid flow path through said chamber.

7. The assembly of claim 1, wherein the fuel container of at least one of said stack units includes a biasing structure which operates to impose a biasing force on an electrode of a cell which is in contact with said fuel container.

8. The assembly of claim 1, wherein said oxidizer supply member is in communication with a source of an oxygen containing gas and is operable to deliver that oxygen containing gas to the oxidizer chamber.

9. The assembly of claim 8, wherein said oxidizer supply member includes a gas inlet and a gas outlet for establishing communication with said source of an oxygen containing gas.

10. The assembly of claim 1, wherein at least one of said at least one oxidizer supply members further includes a biasing structure which operates to impose a biasing force on an electrode of a cell which is in contact therewith.

11. The assembly of claim 1, wherein said electrodes of said cells are electrically interconnected in a series relationship.

12. The assembly of claim 1, wherein said electrodes of said cells are electrically interconnected in a parallel relationship.

13. The assembly of claim 1, wherein said electrodes of said cells are electrically interconnected in a mixed series/parallel relationship.

14. The assembly of claim 1, wherein said fuel chambers of said fuel containers are in fluid communication.

15. The assembly of claim 1, wherein said electrodes and membrane of said cells of said stack units are selected so as to allow for the oxidation of an alcohol in the operation of the cell.

16. The assembly of claim 1, wherein the ion permeable membrane of said cells comprises a perfluorosulfonate membrane.
